(19) United States
(12) Patent Application Publication
(10) Pub. No.: US 2020/0122454 A1
(43) Pub. Date: Apr. 23, 2020

(54) DEVICE FOR COATING PANELS, PRINTING PRESS, AND METHOD FOR COATING PANELS

(71) Applicant: KOENIG & BAUER AG, Wurzburg (DE)

(72) Inventors: Christian ARNOLD, Rimpar (DE); Bernd MASUCH, Kürnach (DE); Wolfgang REDER, Veitshöchheim (DE)

(21) Appl. No.: 16/610,927

(22) PCT Filed: May 15, 2018
(86) PCT No.: PCT/EP2018/062522

§ 371 Date: Nov. 5, 2019

(30) Foreign Application Priority Data
Jul. 26, 2017 (DE) 10 2017 212 828.3

(51) Int. Cl. B41F 31/02; B41F 23/08

(52) U.S. Cl. CPC B41F 31/027; B41F 31/20; B41F 23/08

(57) ABSTRACT

A device coats one or more panels, printed by a coating means, which applies particularly a varnish or a primer. The device utilizes a forme roller which can be brought into rolling contact with the print stock to be coated, in the region of a contact zone, in order to coat the print stock on a side of the print stock facing the forme roller, and also utilizes a feed device supplying the forme roller with coating medium, which interacts, in the region of at least one contact zone on the circumference of the forme roller, with the forme roller, in order to continuously apply the coating medium, which is to be applied to the print stock, to a shell surface of the forme roller to an application width. A removal device, having removal elements, is associated with the forme roller and by the use of which removal device, the coating medium previously applied continuously to the shell surface, over the application width via the feed device, can be removed from the shell surface, before a downstream delivery to the print stock, which removal is, in one or in a plurality of partial width sections, relative to the application width, synchronized to one of a machine and a print stock phase position for one of defined and definable phase lengths. A method for coating and a printing press having a coating device are also disclosed.

### CROSS REFERENCE TO RELATED APPLICATIONS

This application is the U.S. National Phase, under 35 U.S.C. § 371, of PCT/EP2018/062522, filed May 15, 2018; published as WO 2019/020236 A1 on Jan. 31, 2019 and claiming priority to DE 10 2017 212 828.3 filed Jul. 26, 2017, the disclosures of which are expressly incorporated herein in their entireties by reference.

### FIELD OF THE INVENTION

The present invention relates to a device for coating copies, a printing press, and a method for coating copies. The device for coating the printing substrate, printed or to be printed with one or more copies, with the printing medium, in particular a varnish or a printer includes a roller. A feed system supplies the roller with coating medium, which feed system cooperates with the roller, in the region of at least one contact zone on the periphery of the roller, to apply coating medium, that will be applied to the printing substrate, and to a lateral surface of the roller in a continuous layer over an application width. A removal device is assigned to the roller and has removal elements which are controllable separately via a control device. By the use of the removal device, coating medium, applied previously by the feed system to the lateral surface of the roller, in a continuous layer over the application width, can be removed again from the lateral surface selectively, i.e. in one or more sections of partial width relative to the application width, in synchronization with one of the press phase position and the printing substrate phase position for one of defined and definable phase lengths, prior to the transfer downstream. A printing press has a substrate feed system, by which printing substrate to be printed, can be fed in on an intake side. The printing press also has a printing unit that one of operates and can be operated according to a non-impact method. A product receiving unit is also provided, by the use of which product receiving unit, the printed printing substrate can one of be further processed and can be collected in a bundle. At least one coating device is provided one of upstream of the printing unit in the printing substrate path and is provided downstream of the printing unit and can be used to coat the printing substrate that will be printed with the copy downstream or which has already been printed with the copy upstream. The coating device for coating the printing substrate, one of printed and to be printed with one or more copies, with a coating medium, in particular with a varnish or a primer, comprises a forme roller which can be brought into rolling contact, in the region of a tangency zone, with the printing substrate to be coated, in order to coat the printing substrate, on the side thereof that faces the forme roller. A feed system supplies the forme roller with coating medium, and cooperates with the forme roller in the region of at least one contact zone on the periphery of the forme roller, in order to apply coating medium, that will be applied to the printing substrate, to the lateral surface of the forme roller in a continuous layer over an application width. A method for coating a printing substrate, which is already printed or which is still to be printed with one or more copies with a coating medium other than printing ink, is provided. In particular, the coating medium is provided as a varnish or a primer. The coating is carried out on the basis of digital data, based upon a selective removal of previously applied coating medium, using an application element and without a fixed coating forme, without coating. The areas are variable in terms of at least one of number and size and shape and position.

### BACKGROUND OF THE INVENTION

For a variety of applications in the printing industry, it is customary and beneficial for printed copies to receive a coating, e.g., in the form of a varnish coating or some other type of seal, after printing. In some applications it is desirable for the copies to receive a coating over only a portion of their surface, e.g., a spot-varnishing, rather than being coated over their entire surface. Such a coating may serve to enhance the product by producing certain visual effects, or to meet specific requirements in the subsequent post-press processing of the copies.

For industrial applications in the printing industry, especially applications that employ non-impact printing methods, e.g. inkjet methods, it is likewise routine and advantageous to pretreat the printing substrate prior to printing by applying or coating the substrate with a primer or “bonding agent”, which is different, in particular, from ink or printing ink.

EP 1 207 044 B1 discloses a method for producing spot coatings on printing substrates, in which coating material is applied in a coating unit to the entire surface of the printing material, and interacts differently with previously applied inks of different ink systems, thereby creating varying degrees of gloss.

A printing press in which a coating unit or flexographic printing unit is located downstream of an offset printing unit is known from EP 1 389 523 A1.

DE 10 2013 219 259 A1 relates to a printing press that operates without printing formes, in particular an inkjet printing press, in which a web can be printed multiple times by multiple double rows of print heads in succession. A printing ink of a specific color, for example one of the colors black, cyan, yellow and magenta, or a varnish, for example a clear varnish, preferably is and/or can be assigned to each double row of print heads. Upstream of the printing process, a printing substrate preparation unit may be provided in the printing substrate path; in one embodiment, this may be a coating device for applying a primer, for example.

WO 2010/127913 A1 relates to a web-fed rotary offset printing press that has a coating unit comprising an anilox roller with a chamber doctor blade.

DE 10 2012 209 130 A1 relates to an inking system for a digital offset printing press. The goal in this case is to prevent ghosting by a process in which, following the application of ink to an image-producing cylinder by an ink forme roller, any ink that remains is removed from the lateral surface of the roller by an appropriately configured device. In one example for inking a digital offset printing plate having an inking member, dampening solution is first applied to the image-producing cylinder, the layer of dampening solution is patterned by means of digital evaporation, and the printing ink is transferred by the inking member to points on the image-producing cylinder that are free of dampening solution. Any residual ink that is not removed and remains on the inking member is removed before the inking member is inked-up again.

DE 100 52 011 A1, DE 196 17 746 A1 and DE 10 2004 048 150 A1 all relate to the adjustment of ink profiles in inking systems. In such inking systems, the printing ink, which may be roughly pre-profiled, is applied to the forme cylinder, the printing formes of which define the printing pattern to be transferred to the printing substrate.

DE 10 2016 214 899 A1, WO 2004/013 704 A1, and DE 10 2005 021 185 A1 disclose printing presses, each having at least one digital printing apparatus.

DE 10 2005 021 185 A1 discloses a printing press having a sheet feeder, a printing unit and a delivery, wherein a device for pre-coating the printing substrate by means of an inkjet printing process operates without a printing forme is provided upstream of the printing unit in the printing substrate path.

From WO 2016/116168 A1, a roller assembly for coating printing substrate is known, in which coating medium is applied to a roller having saucers, and at points where no coating medium is to be applied to the printing substrate downstream, the coating medium is removed again, at least partially, from the saucers by means of a blower device.

### SUMMARY OF THE INVENTION

The object of the present invention is to provide a device for coating copies, a printing press, and a method for coating copies.

The object is attained, according to the present invention, by the provision of the roller, as a forme roller, and which can be brought into rolling contact, in the region of a tangency zone, with the printing substrate to be coated, in order to coat the printing substrate, on the side thereof that faces the forme roller. The coating medium that has been applied by the feed system to the lateral surface in a continuous layer over the application width, can be removed selectively prior to the downstream transfer of the coating medium to the printing substrate. The removal device, as viewed in the axial direction of the forme roller, has a plurality of removal elements, which can be activated and deactived mechanically independently of one another by respective actuators, and in particular, can be engaged against, and disengaged from the lateral surface of the forme roller and the circumferential region between the sole or the last contact zone with the feed system and the operational direction of rotation and the tangency zone with the printing substrate. As the removal device, a doctor blade device is provided, which doctor blade device is arranged on the periphery of the forme roller, offset from the contact zone with the sole or the last feed element. Alternatively, as removal elements, at least ten doctor blades, which can be engaged independently of one another against the lateral surface in tracks that are offset from one another axially, can be provided. The printing substrate can be coated, on the basis of digital data, with one or more areas without coating, those areas being variable in terms of one of number and size and shape and position, without the use of a fixed coating forme and based upon a selective removal of previously applied coating medium. The forme roller is assigned a removal device having removal elements which can be controlled separately via a control device and by the use of which removal elements coating medium, applied previously by the feed system to the lateral surface in a continuous layer over the application width, can be removed again from the lateral surface selectively, i.e. in one or more sections of partial width relative to the application width, in synchronization with one of the press phase position and the printing substrate phase position for one of defined and definable phase lengths, prior to a downstream transfer of the coating medium onto the printing substrate. Coating medium is applied, over a continuous width, to a lateral surface of a forme roller, which cooperates with the printing substrate in a tangency zone formed between the forme roller and the printing substrate, for the purpose of coating for printing substrate. The forme roller has a smooth surface, in the region of its lateral surface, that is used for the purpose of coating. The applied coating medium is selectively removed again from subsections of the lateral surface of the forme roller before a tengency zone formed with the printing substrate, is reached. The coating medium, which is left on the lateral surface, is transferred, at least partially, to the printing substrate at the point of physical contact therewith.

The advantages achievable by the invention consist, in particular, in that changing coating patterns can be realized even for small-series production runs, without great expenditure in terms of time or material.

For example, for the surface finishing of already printed copies, even small-series or very small-series production runs, e.g. as small as single copies, may be coated, in particular varnished, effectively only in the region of subareas. This is particularly advantageous in the printing of packaging, e.g. for small-series production runs, in production processes involving copies that differ at least in terms of the position of gluing spots or gluing surfaces.

For a printing substrate that has yet to be printed with one or more copies, said substrate can be selectively coated, for example, only in the region of subareas that will subsequently also be printed.

A corresponding device for applying a coating medium other than printing ink or ink, in particular a varnish or a primer, to a printing substrate that has been or will be printed with one or more copies comprises a forme roller, which can be brought into rolling contact, in the region of a tangency zone, with the printing substrate to be coated, in order to coat said substrate on the side thereof that faces the forme roller, and comprises a feed system for supplying the forme roller with coating medium, which cooperates with the forme roller in the region of at least one contact zone on the periphery of the forme roller to apply the coating medium, which will be applied to the printing substrate, to the lateral surface of the forme roller in a continuous layer, over a width, referred to here, e.g. as the application width. For carrying out a partial coating, the forme roller is assigned a removal device having removal elements, by means of which coating medium previously applied by the feed system to the lateral surface in a continuous layer over the application width can be removed selectively from the lateral surface, i.e. in one or more partial-width sections a, e.g., axial sections a, in relation to the application width, in synchronization with the press phase position and/or the printing substrate phase position, for defined and/or definable phase lengths, prior to the downstream transfer of said coating medium to the printing substrate. On circumferential sections lying therebetween, the coating medium remains on the lateral surface and is subsequently transferred, at least partially, onto the substrate. In particular, the coating medium can be removed from the conveying surface in defined subsections that are shorter than the circumferential length of the forme roller and narrower than the application width.

Preferably, a plurality of subsections can be defined independently of one another in terms of their axial position and extension, and in terms of their phase position and phase length with respect to the unwound length of the forme roller and/or with respect to a length of the copy. Preferably, in successive revolutions of the forme roller, the coating medium can be removed from subsections that differ in terms of their axial position or extension and/or in terms of their phase position or length.

For this purpose, the removal device is positioned, in particular cooperating with the forme roller, in the circumferential region between the sole zone of contact or the last zone of contact in the operational direction of rotation with the feed system and the tangency zone with the printing substrate.

The removal device in this case is embodied, in particular, as a device that removes the coating medium by mechanical means. In addition to removal elements that can preferably be engaged and disengaged, in particular doctor blades, blower nozzles are also conceivable as removal elements, which remove the coating medium from the lateral surface using targeted blasts of air. With removal by mechanical means, coating medium is advantageously removed as such, e.g. rather than only individual constituents thereof, as may be the case, for example, with substance mixtures in a partial evaporation or drying.

According to the invention, a printing substrate that has been or will be printed with one or more copies is coated with a coating medium, in particular a varnish or a primer, on the basis of digital data, according to a (preferably indirect) coating method. without a fixed coating forme, with one or more areas that are without coating, said areas being variable in terms of number and/or size and/or shape and/or position. When the coating of gluing spots is to be avoided, these areas without coating will also be referred to in the following as recesses. Areas that are not to be coated with primer may be in the form of recesses, or also contiguous areas that encompass coated subareas.

In a printing press having a printing unit that operates by a non-impact printing method, the possibility of selective coating in a variable pattern, whether with a primer prior to printing or with a varnish after printing, is of particular advantage.

A printing press of this type comprises a printing substrate feed system, by means of which printing substrate to be printed can be fed in on the intake side, a printing unit that operates and/or can be operated according to a non-impact method, and a product receiving unit, by means of which the printed substrate can be further processed and/or can be gathered to form a bundle. In such a printing press, a coating device is provided downstream of the printing unit in the printing substrate path, and/or a coating device is provided upstream of the printing unit in the printing substrate path, by means of which the printing substrate, which has been printed upstream with a copy or is yet to be printed downstream with a copy, can be coated on the basis of digital data by a coating method, in particular an indirect method without a fixed coating forme, with areas that are without coating, said areas being variable in terms of number and/or size and/or shape and/or position.

Advantageous embodiments and refinements of the coating device according to the invention, the printing press according to the invention, and the coating procedure according to the invention will be clear individually or severally from the following description.

### BRIEF DESCRIPTION OF THE DRAWINGS

An exemplary embodiment of the invention is illustrated in the set of drawings and will be described in greater detail in the following in reference to preferred embodiments and variants.

In the drawings:

FIG. 1 shows a schematic representation of a section of printing substrate on which a copy is located;

FIG. 2 illustrates an on/off sequence of an x-th removal element located in an alignment from FIG. 1 for the status of the engaged position and the disengaged position, as a function of the phase position of the copy;

FIG. 3 shows an enlarged subsection of a) a printing substrate bearing a copy and having a gluing area and a recess in the coating with, e.g. a varnish, and b) a print area to be printed on a copy and a recess in the coating with e.g. a primer, said recess lying outside of the print area;

FIG. 4 shows an oblique view of a forme roller that is in physical contact with the printing substrate;

FIG. 5 shows a view from the side of an exemplary embodiment showing the configuration of the coating device;

FIG. 6 shows a perspective view of a forme roller, depicted as transparent, and a removal device associated therewith;

FIG. 7 shows a horizontal sectional view of a section on the left in FIG. 6;

FIG. 8 shows a horizontal sectional view of the section from FIG. 6 shown in FIG. 7;

FIG. 9 shows an enlarged sectional view of a doctor blade assembly of FIG. 8;

FIG. 10 shows a printing press having a printing unit that operates according to a non-impact printing method, and a coating method that operates without a fixed coating forme.

### DESCRIPTION OF PREFERRED EMBODIMENTS

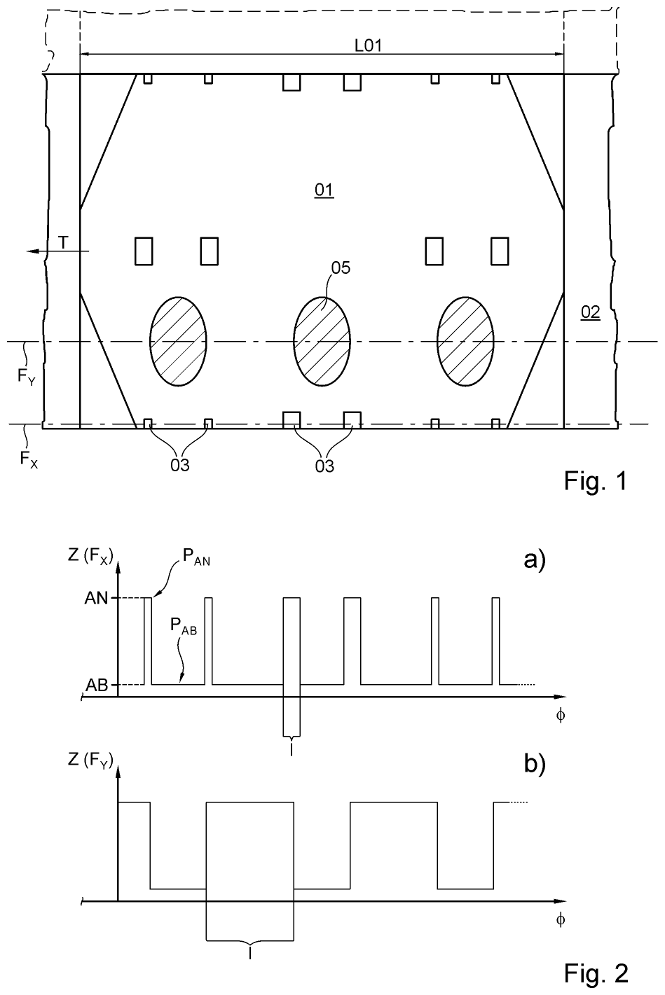

FIG. 1 shows, by way of example, a copy 01 that has already been printed one or more times onto a printing substrate 02 already printed one or more times, i.e. a copy 01 of a printed product located on a printing substrate 02, such as might occur, e.g. in the printing industry, as a final or in particular an intermediate product prior to a post-press processing or final processing step. One or more such copies 01 may be provided on a printing substrate 02 in the form of a sheet, or, as in the example here, multiple copies 01 may be provided one behind the other and optionally also side by side on a web-format printing substrate 02, e.g. a printing substrate web 02. Generally, the copies 01 of a series may all be the same or may differ at least partly in terms of form and/or print image.

When forme-free or non-impact printing methods are used, in particular, the application of coating media outside of the printing process itself may be necessary. This may involve, for example, an application of primer prior to printing or also a varnish coating that takes place after printing.

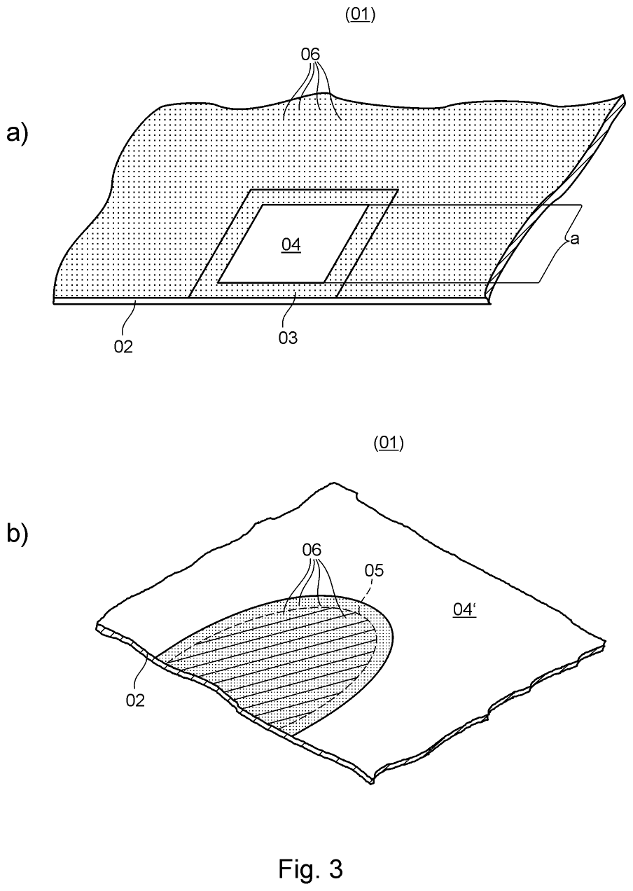

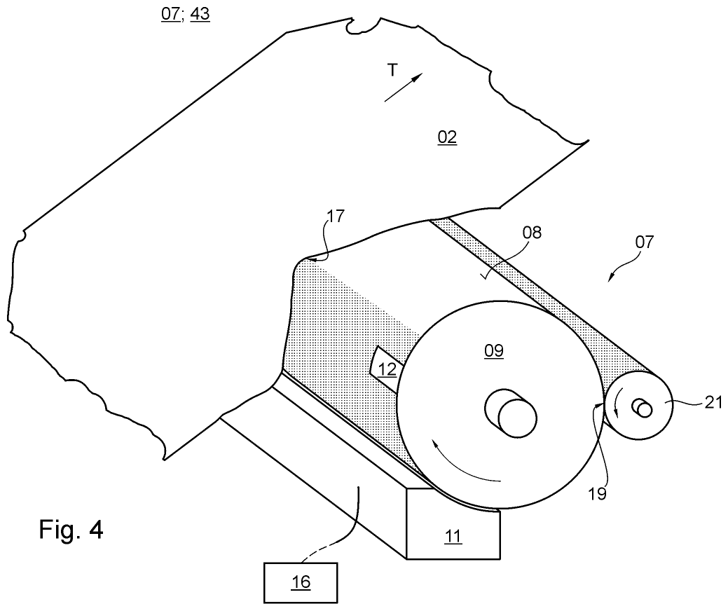

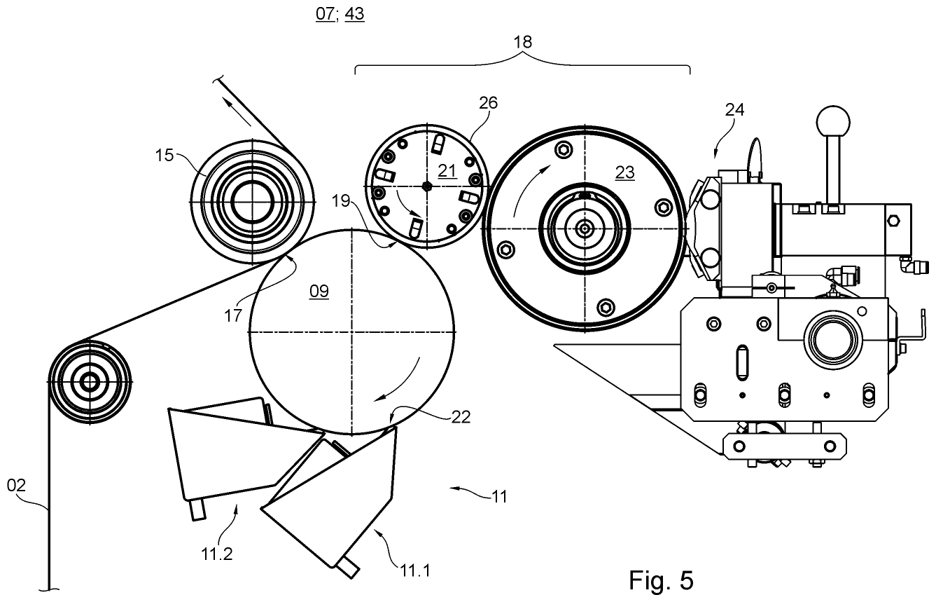

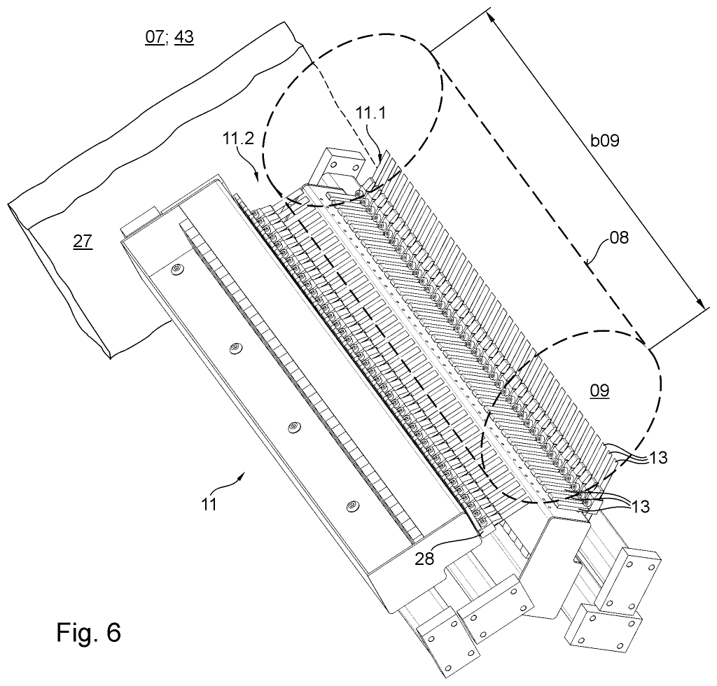

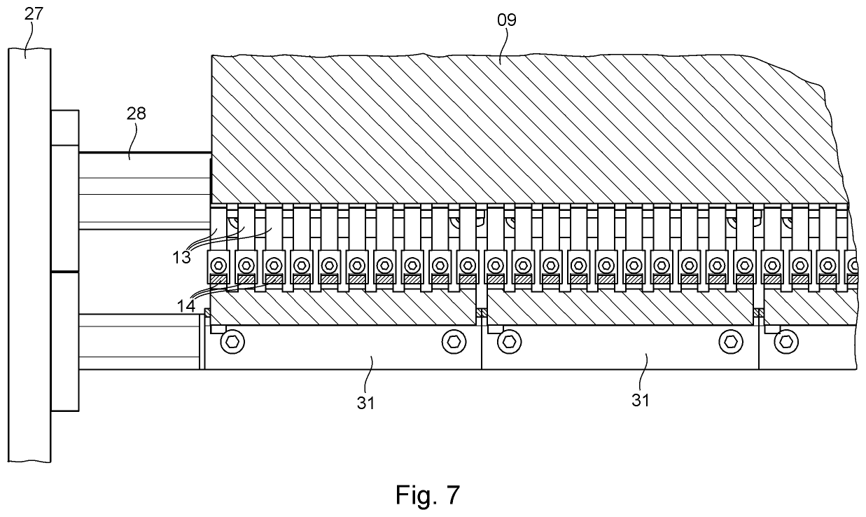

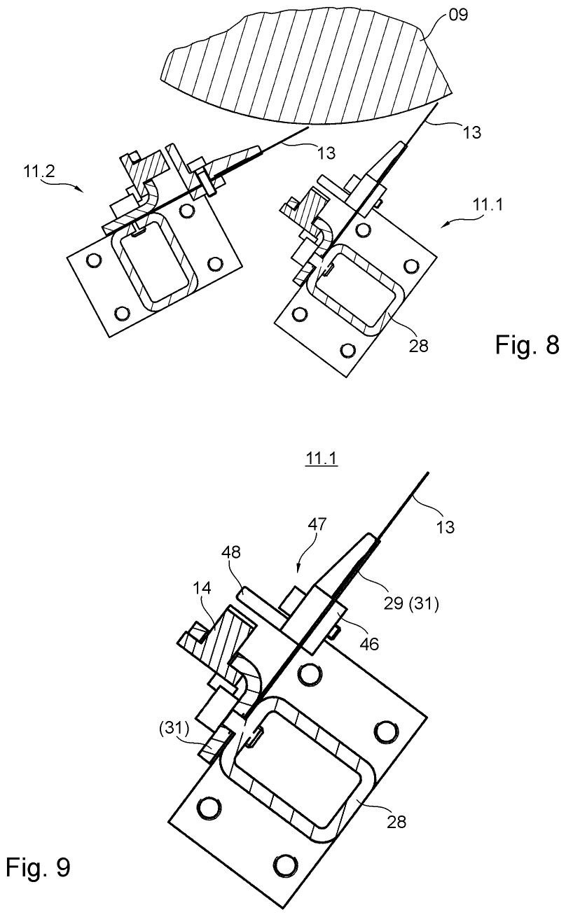

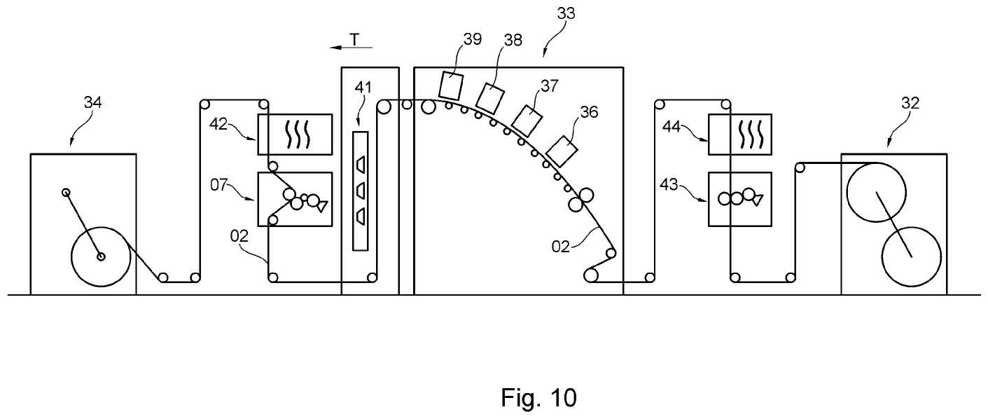

In some applications, in particular with the production of packaging, it is particularly advantageous for the copies 01 to receive a coating, e.g. known as a spot coating, over only a portion of the copy surface, rather than over the entire surface. In packaging production, it is particularly important during the coating, in particular varnishing, of copies 01 that later gluing areas 03, i.e. areas intended for gluing, also referred to as “gluing spots”, should be excluded from the coating or varnishing process over at least a portion of the intended gluing surface (see, e.g., in FIG. 3a, the schematically illustrated area 04 (also referred to as recess 04) that is excluded from the coating process in a section of a copy 01 to which coating medium 06, in particular varnish 06, is otherwise applied).

Gluing areas 03 are understood as those areas on the copy 01 that in the later product will be covered by an overlap, and that are intended for gluing to another part of the same copy 01 or to another product component. Locally, the gluing area 03 may, but is not required to, come in contact with glue over its entire surface or be involved in the gluing process. The recess 04 assigned to gluing area 03 can generally correspond in size and shape to the surface area provided for the gluing area 03, or may even be smaller than said surface area, as long as it ensures adhesion of the glue at the relevant “gluing spot” over an area of sufficient size. In principle, the actual gluing at a “gluing spot” may also be produced at multiple smaller recessed areas.

It may also be advantageous for only those areas 05 that are designated for printing, e.g., print areas 05, to be coated with a substance known as a primer 06′ (a fluid used for pretreating the printing substrate 02) as a coating medium 06′, prior to printing. In that case, the areas to be coated may correspond precisely to the areas 05 to be printed or may be slightly larger than these, for good measure. Those areas 04′ that will not be coated with primer may be recesses 04′, or may also be areas 04′ that are contiguous with coated subareas and are encompassed by these (see, e.g., FIG. 3b).

To allow even small-series or very small-series production runs of copies 01, e.g. as small as a single copy, that differ at least terms of the location of gluing areas 03 and/or printing areas 05 to be effectively coated, in particular varnished and/or pretreated selectively with primer 06′, in particular in an embodiment of a printing press set out below, a device for coating 07; 43, or coating device 07; 43, is provided, by means of which the printing substrate 02 bearing the copies 01 can be coated, on the basis of digital data, with areas 04; 04′ that are without coating or coating medium 06; 06′, in particular recesses 04; 04′, said areas being variable in terms of number and/or size and/or shape and/or position, by means of a coating method, i.e., without a fixed coating or varnishing forme, in particular an indirect method of this type.

This applies to both the embodiment of the coating device 07 as, e.g., a varnishing device 07 for coating printing substrate 02 that has already been printed, and an alternative embodiment of the coating device 43 as, e.g., an application device 43 for primer 06′ for coating a printing substrate 02 as yet to be printed. In a printing press described in greater detail below, only one of the two devices 07; 43 or both of the devices 07; 43 may be provided in the printing substrate path.

In contrast to the exclusion of gluing areas 03 from coating with varnish 06, when areas 05 that will not be printed are excluded from coating with primer 06′, in some cases the surface area of these coating-free areas 04′ may be larger than the surface area to be coated. It is also possible for the coating medium 06′ to be completely removed again in certain axial sections a over the length L01, e.g. copy length L01.

Because the structure is basically the same, the same reference signs will be used to describe the components and the point at which said components interact with the printing substrate 02 for the two embodiments of the device 07; 43. The following statements therefore apply to both uses, i.e. to the use as a varnishing device 07 and to the use as an application device 43 for primer 06′.

Device 07; 43 can be used to coat a copy 01, e.g. over the length of the copy 01 in the transport direction T as well as transversely thereto, each copy having a plurality of variably positionable areas 04; 04′ where coatings 06; 06′ are omitted, e.g. recesses 04; 04′.

An aforementioned device for coating 07; 43, or coating device 07; 43, in particular a varnishing device 07 or an application device 43 for primer 06′, which operates without a fixed coating forme, can generally function or be configured based upon any coating method without a fixed coating forme that is physically and chemically appropriate for the coating medium 06; 06′ to be applied, in particular for the varnish 06 or primer 06′ to be applied.

However, the coating device 07; 43, according to the invention, that operates according to a coating method without a fixed coating forme, is based on a selective removal of coating medium 06; 06′ that has previously been applied to the transport surface 08, in particular over the entire surface or over a continuous width thereof, of an application element 09 that is part of the coating device 07; 43 in the coating medium path, at a location in the coating medium path of the coating device 07; 43 that lies in front of or upstream of the point of application onto the printing substrate 02. Although the application element 09 may be embodied as a circulating belt or in some other way that will enable a continuous conveyance of coating medium 06; 06′, here the coating medium 06; 06′ is preferably selectively removed from the transport surface 08, formed as the lateral surface 08, of an application element 09, e.g. forme roller 09, configured as a cylinder 09 for applying the coating medium 06; 06′ onto the printing substrate 02. A device 07; 43 that operates according to the aforementioned principle is insensitive to physical or chemical differences over broad ranges within the spectrum of coating media 06; 06′ that may be used.

The application element 09, preferably in the form of a forme roller 09, has a smooth and/or hard surface in the region of its lateral surface 08 that is usable or effective for the coating process. Said hardness should have a hardness grade of at least 800 HRV, preferably at least 1000 HRV, and/or the smoothness should have a surface roughness of at most Rz 10, in particular at most Rz 2. Cylinder 09, or at least the lateral surface 08 thereof, which is usable or effective for the coating process, is preferably made of ceramic.

The application element 09, preferably embodied as forme roller 09, is assigned a preferably mechanically functioning removal device 11, in particular doctor blade device 11, by means of which coating medium 06; 06′ previously applied in a continuous layer over an application width to the lateral surface 08 by a feed system 18, can be removed again from the conveying surface, prior to the downstream transfer onto the printing substrate 02, selectively, i.e. in one or more sections a of only partial width relative to the application width, in synchronization with the press phase position and/or the printing substrate phase position, for defined and/or definable phase lengths l, in particular only in defined subsections 12 that are shorter than the circumferential length and are narrower than the usable cylinder width b09 and/or the application width, e.g. by at least a factor of ten, preferably at least a factor of fifty. For this process, multiple phase lengths l in relation to the copy phase position of a copy 01 can be defined and/or definable for removal of the coating medium 06; 06′.

For this purpose, a plurality of removal elements 13, in particular doctor blades 13, e.g. at least ten, in particular at least 50, which are narrower than the application width and/or in particular are narrower than a usable cylinder width b09, e.g. narrower at least by a factor of 10 or even by a factor of 50 than the application width and/or than the usable cylinder width b09, are preferably provided, which are or can be engaged and disengaged via actuators 14, which are actuated by control means of a control device 16, in synchronization with the printing substrate feed rate. In this context, “synchronized” should be understood not as a strict uniform sequence, but as a definable or defined correlation of engagement/disengagement to the relevant phase. This correlation can generally range from a sequence that is fixed and optionally uniform over a plurality of copies 01 to irregular sequences that are redefined for each copy 01. The selective removal in the subsections 12 or in partial-width sections a is thus accomplished by a limited subsection 12 of the coating medium 06; 06′, which was applied previously over the application width, being freed of coating medium 06; 06′ in tracks that are defined in the axial direction by removal elements 13, through the temporary engagement of one or of a group of removal elements 13 that extend axially when acting as a doctor blade. During this time, removal elements 13 of other tracks remain disengaged, so that the coating medium 06; 06′ in these tracks remains on the lateral surface 08 and is or can be transferred to the printing substrate 02, e.g. in the region of the tangency zone 17. Removal elements 13 are preferably provided, in terms of number and arrangement, such that a resolution, i.e. a variation in the removal width, is or can be achieved in steps of at most 10 mm, preferably at most 6 mm.

Preferably, the removal element(s) 13 relating to the, or to the one, partial-width track can be engaged and disengaged multiple times over the length L01 of a copy 01. In other words, over a rolling length of the forme roller 09 that corresponds to the length L01 of a copy 01 currently being coated, multiple engagement phases P_{ON} and multiple disengagement phases P_{OFF} may be provided or cycled through. FIG. 2a shows, by way of example, an on/off sequence of an x-th removal element 13x located in an alignment Fx extending through gluing areas 03 (see, e.g., FIG. 1) for the status Z of the engaged position ON and disengaged position OFF, dependent upon the copy phase position Φ, i.e., the phase position Φ of the copy 01 already printed upstream or yet to be printed downstream in the printing substrate path, relative to the coating device 07. FIG. 2b shows, by way of example, an on/off sequence of a y-th removal element 13y located in an alignment Fy extending through print areas 05 (see, for example, FIG. 1) for the status Z of the engaged position ON and disengaged position OFF, dependent upon the copy phase position Φ. In practice, the copy phase position Φ may be based on a direct determination of the position of the copy 01 or of the printing substrate 02 itself, or may be derived from a press phase position, i.e. from phase position information and/or phase movement information from transport means that convey the copy 01 or printing substrate 02 in a defined manner to the and/or through the coating device 07; 43, or the press per se. The copy phase position Φ for controlling the synchronized engagement/disengagement is preferably obtained via information relating to the printing substrate position or press phase position, and is further processed accordingly by control means of a control device 16. For this purpose, control device 16 is in signal communication with means for supplying information relating to the printing substrate phase position and/or the press phase position.

The removal device 11 is preferably embodied such that multiple subsections 12 along the circumferential or unwound length of the forme roller 09 can be defined independently of one another in terms of their axial position and extension and in terms of their phase position and phase length, and/or can be freed independently of one another of coating medium 06; 06′, and/or in that in successive revolutions of forme roller 09, the coating medium 06; 06′ can be removed from subsections 12 that differ per se in terms of their axial position or extension and/or in terms of their phase position or phase length. The subsections 12 that have been freed of coating medium 06; 06′ bring about the coating medium-free areas 04; 04′ or recesses 04; 04′ to be produced on the printing substrate 02, taking into account the transport path yet to be traveled by coating medium 06; 06′ and printing substrate 02.

Forme roller 09 and a printing substrate 02 to be coated can be brought into contact with one another in the region of a mutual tangency zone 17, so that said printing substrate can be coated by the forme roller 09 on the side facing the latter. Depending on the wrap, tangency zone 17 may be quasi-linear or areal. Forme roller 09 and a counter-roller 15 preferably together form a nip point, through which the printing substrate 02 to be coated can be guided and in which the side facing the forme roller 09 can be coated. The nip point then forms the tangency zone 17 or, in the case of a partial wrap, lies within the tangency zone 17. Counter-roller 15 is preferably configured as having an elastic and/or compressible surface layer, at least in the region of its lateral surface that is usable for and/or that effects the transport of coating medium. Preferably, it is embodied as a roller 15 that has a rubber layer or rubber coating provided in at least the usable or operative lateral surface area.

Forme roller 09 receives the coating medium 07; 43 by contact with a feed system 18 in the region of a contact zone 19 formed on the periphery of the forme roller 09. The width, in particular continuous, over which coating medium 06; 06′ is or can be supplied to the forme roller 09 by the feed system 18 is also referred to in the following as the application width.

In principle, feed system 18 may be formed directly by a coating medium reservoir, e.g., by a chamber doctor blade that is or can be engaged against the forme roller 09, in which case the contact zone 19 is formed by the direct contact with the ink therein, or said feed system may be formed by a trough-like container with coating medium 06; 06′, into which a part of the forme roller 09 that forms the contact zone 19 dips. In another embodiment, feed system 18 may be formed by a type of spray bar, by which coating medium 06; 06′ is applied to the forme roller 09 in a circumferential section that forms the contact zone 19.

In the embodiment preferred here, however, forme roller 09 receives the coating medium 06; 06′ not directly from a coating medium reservoir, but from another roller 21 located upstream with respect to the flow of coating medium. In this case, the contact zone 19 relating to the supply of coating medium to the forme roller 09 is formed by the nip point between the two rollers 09; 21. Roller 21 may generally be embodied as a dipping or anilox or saucer roller, and may be embodied as cooperating with a coating medium reservoir, e.g. with a chamber doctor blade or with a container already mentioned above, the operative width of which is optionally variable. Preferably, however, it is configured as a transfer roller 21, which receives the coating medium 06; 06′ via a nip point formed with an additional roller 23 upstream. Transfer roller 21 is preferably configured as having an elastic and/or compressible surface layer 26, at least in the region of its lateral surface that is usable for and/or that effects the transport of coating medium. Preferably, it is embodied as a roller 21 that has a rubber layer 26 or rubber coating 26 provided in at least the usable or operative lateral surface area.

For the supply of coating medium 06; 06′, it is also generally possible for a plurality of such rollers 21, in particular transfer rollers 21, to be provided in a row along the periphery of the forme roller 09, each forming a contact zone 19 therewith. In this case, the last contact zone 19 is understood as the last contact zone 19 that is passed through in the operational direction of rotation of the forme roller 09 prior to passage through the tangency zone 17 with the printing substrate 02.

In the embodiment that is preferred here, the sole or last contact zone 19 with the feed system 18 and the sole or first subsequent operational point 22 of the removal device 11 on the circumference of the forme roller 09 in the direction of rotation are provided spaced apart from one another by at least several degrees, e.g. by at least 10°, here preferably even by more than 45°.

The roller 23 for supplying transfer roller 21 with coating medium 06; 06′ can generally be an additional roller 23 of a roller train that continues further upstream, at the end of which is a coating medium reservoir already described above and optionally having a variable operational width. In the embodiment preferred here, however, it is embodied as the last roller 23 upstream, and coating medium 06; 06′ is applied to it in the region of a zone of contact with a coating medium reservoir. The application width at this contact zone may be variable. Although roller 23 may be embodied as a dipping roller that dips into a coating medium reservoir, it is preferably embodied as an anilox roller 23. For the application of coating medium to anilox roller 23, said roller cooperates with the coating medium reservoir of an application device 24 comprising a doctor blade, and in particular cooperates with a chamber doctor blade 24.

Regardless of the particular embodiment and type of feed system 18 used, the application width may be fixed or may be adjustable to a variable printing substrate width. With a variable printing substrate width, however, for narrower printing substrates 02 it may be provided that coating medium 06; 06′ that is applied too wide laterally is or can be removed by means of lateral removal elements 13 that remain engaged continuously throughout the relevant production situation.

In general, the removal device 11 may be of any embodiment that will enable it to selectively remove, for example by evaporation, dabbing, or suction, previously applied coating medium 06; 06′ in subsections 12 of a layer of coating medium that is first applied over a continuous application width to the lateral surface 08 of the forme roller 09, said subsections being defined or definable, e.g. generally newly defined or definable from copy 01 to copy 01. In this case, the “decrease” or the “removal” refers not to a stripping away of a partial layer, i.e. a metered adjustment of a residual layer thickness, but to a removal which is ideally residue-free, taking into account the limitations of the medium used. Accordingly, “engagement” refers to an actual contact, in particular a force-actuated contact between removal element 13 and lateral surface 08.

Preferably, however, a doctor blade device 11 is provided as removal device 11, which, as viewed in the axial direction of forme roller 09, has a plurality of doctor blades 13, e.g. at least 10, which can be engaged and disengaged mechanically independently of one another by respective actuators 14 in the peripheral region between the sole or the last contact zone 19 in the operational direction of rotation and the tangency zone 17 on the lateral surface 08 of forme roller 09. Said doctor blades 13 may be embodied as individual blades or alternatively in the form of tongues of a doctor blade sheet that is incised multiple times from one side. Said device may also have a combined form, in which a plurality of such incised doctor blade sheets are arranged side by side.

The individual doctor blades 13 are engaged and disengaged in particular by means of separately controllable actuators 14. The concept of an engagement and disengagement, i.e. the movement of doctor blade 13 into an engaged position ON or a disengaged position OFF, by means of the respective actuator 13, also covers solutions in which only one adjustment direction, e.g. an engagement, i.e. the movement of doctor blade 13 into an engaged position ON, is actively brought about by the actuator 14, while the other direction is brought about by a return movement, for example, a return movement due to spring force or gravity, while actuator 14 is inactive.

For controlling the doctor blade device 11 or the actuators 14 associated with the doctor blades 13, a control device 16 that acts on the actuators 14, activating and deactivating the removal elements 13 in synchronization with the printing substrate phase position and/or the press phase position according to a predefinable pattern, in particular engaging and disengaging said removal elements, is provided. The pattern of activation or engagement corresponds to the coating medium-free areas 04; 04′ or recesses 04; 04′ to be taken into account on the copy 01. When passing through the lateral surface area in the pattern of the recesses 04; 04′ to be provided on the copy 01, one or more doctor blades 13 is/are engaged individually or grouped in multiples against the lateral surface 08 for a circumferential section corresponding to the length of the recess 04; 04′, and thereafter is/are disengaged again. The width of the individual doctor blade or the group of doctor blades 13 corresponds in this case to the width of the recess 04; 04′. The pattern for engagement of the doctor blades 13 is obtained, for example, from data on which the previous printing was based, e.g. print image data or print image raw data, and is correlated with the printing substrate phase position or press phase position.

Generally, any possible drive means may be provided as actuators 14. Advantageously, however, pressure medium-operated actuators 14, e.g. pneumatic or hydraulic actuating means, or electromagnetic actuating means 14, in particular electromagnets 14, electromagnets are provided. The electromagnets 14 are preferably switchable at a frequency of at least 100 Hz.

The removal device 11 embodied as doctor blade device 11 is disposed on the periphery of the forme roller 09, preferably offset, i.e. spaced apart from the contact zone 19 with the feed system 18. Regardless of their particular configuration, the doctor blade device 11 comprises as removal elements 13 at least ten doctor blades 13 that can be engaged independently of one another on the lateral surface 08 in tracks that are offset from one another axially.

Generally, all of the doctor blades 13 of doctor blade device 11 can be arranged in side-by-side alignment in one axially extending row. In such cases, a gap-free arrangement is advantageous, so that between adjacent engaged doctor blades 13, ideally no coating medium 06; 06′ is left on the lateral surface 08.

In an advantageous refinement shown, two axially extending rows, each containing doctor blades 13 spaced apart from one another by no more than one doctor blade width, are arranged offset relative to one another in the circumferential direction, so that the tracks extending in the circumferential direction with the doctor blades 13 in their engaged position ON against the lateral surface 08 proceed at least uninterrupted in the axial direction, and preferably overlap. The overlap may be 0.5 to 2 mm, for example. The two rows of doctor blades 13, together with their drive mechanism and bearing, form a first and a second doctor blade assembly 11.1; 11.2 in the operational direction of rotation.

In an advantageous embodiment, doctor blades 13 having a functional edge that measures 5 to 7 mm in width, in particular 6 mm in width, are arranged spaced apart from one another axially by 3 to 5 mm, in particular by 4 mm, in their respective row. The rows are arranged one behind the other such that the doctor blades 13 of one row or doctor blade assembly 11.1; 11.2 come to rest centered on the interruptions in the other row or doctor blade assembly 11.2; 11.1.

Preferably, at least 250 such doctor blades 13 per row and/or a total of at least 500 doctor blades 13 are provided, to form 500 axially staggered, advantageously overlapping tracks.

If multiple rows, e.g. two, are provided offset along the circumference, the time delay resulting from the rotational speed is taken into consideration during actuation or during engagement and disengagement.

In an advantageous embodiment, the control of engagement and disengagement is coupled to the actuation of the inkjet heads 36; 37; 38; 39 or print head groups 36; 37; 38; 39.

Preferably, a marginal terminus of the row of doctor blades 13 is such that it lies with its marginal end spaced inwardly from the end face of the forme roller 09, but projecting laterally beyond the alignment of a maximum printing substrate width to be coated.

Generally, the doctor blades 13, which can be engaged and disengaged independently of one another, can be mounted as desired, directly or indirectly in or on a frame 27 of the coating device 07; 43, in such a way that they can be engaged with their functional edge against the lateral surface 08 in the provided tracks, and then disengaged again. This can be accomplished by an articulated mounting of the doctor blades 13 on a cross-member 28, for example.

In a preferred embodiment, the doctor blades 13 are affixed directly or via elastically deformable holding means 29 on a cross-member 28, and can be moved by the respectively associated actuators 14, under reversible deformation of the doctor blade 13 and/or the holding means 29, with the functional edge of the doctor blade moving between an engaged position ON and a disengaged position OFF. If holding means 29 that are different from the doctor blade 13 are provided, these may be embodied as individual resilient plate strips or spring plate strips 29 or as tongues 29 of a spring plate 31 that has multiple incisions along one side (see, e.g., FIG. 9). In this case, the respective doctor blade 13 is fastened to the relevant holding means 29 via a fastener 46.

The actuators 14 are also mounted directly or indirectly in or on the frame 27 of the coating device 07; 43 so as to allow them to come directly or indirectly into operative contact with the doctor blades 13 or with the holding means 29 thereof. They are likewise arranged on the cross-member 28, for example, and cooperate with a magnetic surface, which is provided on the doctor blade 13 or on the optionally provided holding means 29. This surface may, for example, be a surface on one arm 48 of an L-shaped tension element 47, the other arm 48 of which is disposed on the holding means 29 or the doctor blade 13, with said surface being opposite the inactive electromagnet 14 with a gap therebetween. With this embodiment, a defined bending of the doctor blade/holding means assembly occurs upon tilting of the tension element 47. The L-shaped tension element 47 may be embodied such that it also comprises the fastener 46 that forms a clamping connection, for example.

In a preferred use, an aforementioned coating device 07; 43, by means of which the printing substrate 02 bearing the copy 01 can be coated, on the basis of digital data, by a preferably indirect method based on a selective removal of previously applied coating medium, i.e. without a fixed coating forme, with coating medium-free areas 04; 04′ or recesses 04; 04′ that are variable in terms of number and/or size and/or shape and/or position, is provided in a printing press that comprises a printing substrate feed system 32, a printing unit 33 that operates and/or is operable according to a non-impact method, i.e. an inkjet printing unit 33, and a product receiving unit 34.

Such a printing unit 33 may comprise multiple printing points and/or inkjet print heads or print head groups 36; 37; 38; 39 to be traversed in succession, which can print the printing substrate 02 in succession with multiple inks. The printing substrate feed system 32, e.g. a sheet feeder or particularly a roll unwinder 32, can feed sheet-format or preferably web-format printing substrate 02 in on the intake side for printing, while the product receiving unit 34 can combine the printed and coated printing substrate 02 for post-press processing and/or in a bundle, e.g. in a pile, or particularly in its embodiment as a roll winder 34, in a wound roll.

The coating device 07 embodied as a varnishing device 07, for example, is located downstream of the printing unit 33, and in particular downstream of a dryer 41 located downstream of the printing unit 33 in the printing substrate path, and is located upstream of the product receiving unit 34. Between the coating device 07 and the product receiving unit 34, a dryer 42 acting on the coated side of the printing substrate may be provided along the printing substrate path. An application device 43 for applying the so-called primer 06′, which may be embodied as a coating device 43 as described above, may be provided upstream of the printing unit 33 in the printing substrate path and may optionally be followed by a dryer 44 downstream.

In the application of a coating medium 06; 06′, in particular a varnish 06 or a primer 06′, to a printing substrate 02 that has been printed with one or more copies 01, coating is thus carried out, on the basis of digital data, according to a preferably indirect method that is based on a selective removal of previously applied coating medium, i.e. without a fixed coating forme, with coating medium-free areas 04; 04′ or recesses 04; 04′ that are variable in terms of number and/or size and/or shape and/or position. This is accomplished, in particular, in that coating medium 06; 06′ is applied over a continuous roller width b09 to a forme roller 09 that cooperates with the printing substrate 02 to coat said substrate, the applied coating medium 06; 06′ is selectively removed again from subsections 12 of the lateral surface 08 of the forme roller 09 before said roller reaches the tangency zone 17 formed with the printing substrate 02, and the coating medium 06; 06′ remaining or left on the lateral surface 08 is then transferred to the printing substrate 02 by physical contact therewith, at least partially, i.e. in the layer thickness picked up by the printing substrate 02 during rolling contact.

Said removal is preferably carried out by the engagement, in synchronization with the copy phase position, of subsets of the number of removal elements 13, in particular doctor blades 13, arranged offset axially relative to one another, which can be engaged and disengaged mechanically independently of one another against the lateral surface 08 of the forme roller 09. In a preferred implementation, the printing substrate 02 is printed one or more times inline in a non-impact process, in particular in the inkjet process, before or after coating, i.e. upstream or downstream in the press that comprises the coating device 07; 43.

The described coating device 07; 43 may also optionally be operated or used for full-surface coating; in this operating mode all removal elements, or at least those removal elements 13 that are aligned with the printing substrate width and/or copy width, remain inactive or disengaged over the copy length L01 or even throughout the production period. If the width of the copy 01 or of the printing substrate 02 is narrower than that of the maximum possible printing substrate width or copy width, removal elements 13 that are positioned to the side of the printing substrate alignment or copy alignment may be activated or engaged for the relevant production period.

While preferred embodiments of a device for coating copies, a printing press, and a method for coating copies, all in accordance with the present invention, have been set forth fully and completely herein above, it will be apparent to one of skill in the art that various changes could be made without departing from the true spirit and scope of the subject invention, which is accordingly to be limited only by the appended claims.

1-24. (canceled)

25. A device for coating a printing substrate (02), printed or to be printed with one or more copies (01), with a coating medium (06; 06′), in particular a varnish (06) or a primer (06′), said device comprising
a roller (09),
and a feed system (18) for supplying the roller (09) with coating medium (06, 06′), which system cooperates with the roller (09), in the region of at least one contact zone (19) on the periphery of said roller, to apply coating medium (06; 06′) that will be applied to the printing substrate (02) to the lateral surface (08) of the roller (09) in a continuous layer over an application width, and
a removal device (11) assigned to the roller (09) and having removal elements (13), which are controllable separately via a control device (16), and by means of which coating medium (06; 06′) applied previously by the feed system (18) to the lateral surface (08), in a continuous layer over the application width, can be removed again from the lateral surface (08) selectively, i.e. in one or more sections of partial width relative to the application width, in synchronization with the press phase position and/or printing substrate phase position for defined and/or definable phase lengths (l), prior to the transfer downstream,
characterized in that
the roller (09), as a forme roller (09), can be brought into rolling contact, in the region of a tangency zone (17), with the printing substrate (02) to be coated, in order to coat said printing substrate on the side thereof that faces the forme roller (09),
the coating medium (06; 06′) that has been applied by the feed system (18) to the lateral surface (08) in a continuous layer over the application width can be removed selectively prior to the downstream transfer of said coating medium to the printing substrate (02),
in that the removal device (11), as viewed in the axial direction of the forme roller (09), has a plurality of removal elements (13), which can be activated and deactivated mechanically independently of one another by respective actuators (14), in particular can be engaged against and disengaged from the lateral surface (08) of the forme roller (09) in the circumferential region between the sole or the last contact zone (19) with the feed system (18) in the operational direction of rotation and the tangency zone (17) with the printing substrate (02), wherein as the removal device (11), a doctor blade device (11) is provided, which is arranged on the periphery of the forme roller (09), offset from the contact zone (19) with the sole or last feed system (18), and/or which comprises as removal elements (13) at least ten doctor blades (13), which can be engaged independently of one another against the lateral surface (08) in tracks that are offset from one another axially.

26. The device according to claim 25, characterized in that the removal device (11) is positioned to cooperate with the forme roller (09) in the circumferential region between the sole or last contact zone (19) with the feed system (18) in the operational direction of rotation and the tangency zone (17) with the printing substrate (02).

27. The device according to claim 25, characterized in that a control device (16) is provided, which acts on the actuators (14) to activate and deactivate, in particular to engage and disengage the removal elements (13), in synchronization with the printing substrate phase position and/or press phase position, according to a predefinable pattern, and/or in that electromagnets (14) are provided as actuators (14).

28. The device according to claim 25, characterized in that two axially extending rows of doctor blades (13), which are spaced apart from one another by no more than one doctor blade width, are arranged offset from one another in the circumferential direction such that the tracks extending in the circumferential direction on the lateral surface (08) when the doctor blades (13) are in the engaged position continue at least uninterrupted or preferably overlap, as viewed in the axial direction, and/or in that the doctor blades (13), which can be engaged and disengaged independently of one another, are held on a cross-member (28) directly or via elastically deformable holding means (29), and can be moved between an engaged position (ON) and a disengaged position (OFF) by the respectively associated actuators (14), under reversible deformation of the doctor blade (13) and/or the holding means (29).

29. The device according to claim 25, characterized in that the forme roller (09) has a smooth and/or hard surface over the entire area of its lateral surface (08) that is used for coating.

30. The device according to claim 25, characterized in that the feed system (18) comprises a roller (21) that forms the contact zone (19) with the forme roller (09).

31. The device according to claim 25, characterized by its configuration as a varnish-coating device (07) for coating already printed printing substrate (02) with a varnish (06) as the coating medium (06), or by its configuration as an application device (43) for coating an as yet unprinted printing substrate (02) with a primer (06′) as the coating medium (06′).

32. A printing press having a printing substrate feed system (32) by which printing substrate (02) to be printed can be fed in on the intake side, a printing unit (33) that operates and/or can be operated according to a non-impact method, and a product receiving unit (34), by means of which the printed printing substrate (02) can be further processed and/or can be collected in a bundle, wherein at least one coating device (07; 43) is provided upstream of the printing unit (33) in the printing substrate path and/or is provided downstream of the printing unit (33) and can be used to coat the printing substrate that will be printed with the copy (01) downstream or which has already been printed with the copy upstream, wherein the coating device (07; 43) for coating the printing substrate (02), printed or to be printed with one or more copies (01), with a coating medium (06; 06′), in particular a varnish (06) or a primer (06′), comprises a forme roller (09), which can be brought into rolling contact, in the region of a tangency zone (17), with the printing substrate (02) to be coated, in order to coat said printing substrate on the side thereof that faces the forme roller (09), and a feed system (18) for supplying the forme roller (09) with coating medium (06; 06′), which cooperates with the forme roller (09) in the region of at least one contact zone (19) on the periphery of said roller, in order to apply coating medium (06; 06′) that will be applied to the printing substrate (02) to the lateral surface (08) of the forme roller (09), in a continuous layer over an application width, characterized in that the printing substrate (02) can be coated, on the basis of digital data, with one or more areas (04; 04′) without coating, said areas being variable in terms of number and/or size and/or shape and/or position, without the use of a fixed coating forme and based upon a selective removal of previously applied coating medium (06), and in that the forme roller (09) is assigned a removal device (11) having removal elements (13), which can be controlled separately via a control device (16) and by means of which coating medium, applied previously by the feed system (18) to the lateral surface (08), in a continuous layer over the application width, can be removed again from the lateral surface (08) selectively i.e. in one or more sections of partial width relative to the application width, in synchronization with the press phase position and/or printing substrate phase position for defined and/or definable phase lengths (l), prior to the downstream transfer of said coating medium onto the printing substrate (02).

33. The printing press according to claim 32, characterized in that the coating device (07; 43) is embodied in accordance with the device according to any of claims 2 to 14.

34. The printing press according to claim 32, characterized in that the coating device (07) located downstream of the printing unit (33) in the printing substrate path is embodied as a varnishing device (07) for applying varnish (06) to printed printing substrate (02).

35. The printing press according to claim 32, characterized in that the coating device (43) located upstream of the printing unit (33) in the printing substrate path is embodied as an application device (43) for applying primer (06′) to the printing substrate (02) to be printed downstream.

36. A method for coating a printing substrate (02), already printed or still to be printed with one or more copies (01), with a coating medium (06; 06′) other than printing ink, in particular a varnish (06) or a primer (06), wherein the coating is carried out on the basis of digital data, based upon a selective removal of previously applied coating medium (06), using an application element (09) and without a fixed coating forme, with areas (04; 04′) without coating, said areas being variable in terms of number and/or size and/or shape and/or position, characterized in that
coating medium (06; 06′) is applied over a continuous width to a lateral surface (08) of a forme roller (09), which cooperates with the printing substrate (02) in a tangency zone (17) formed between forme roller (09) and printing substrate (02) for the purpose of coating said printing substrate, and which has a smooth surface in the region of its lateral surface (08) that is used for the purpose of coating,
the applied coating medium (06; 06′) is selectively removed again from subsections (12) of the lateral surface (08) of the forme roller (09) before a tangency zone (17) formed with the printing substrate (02) is reached,
and then the coating medium (06; 06′) left on the lateral surface (08) is transferred at least partially to the printing substrate (02) at the point of physical contact therewith.

37. The method according to claim 36, characterized in that the removal is accomplished by the engagement, synchronized with a phase position (ϕ) of the copy (01) that has already been printed upstream or has yet to be printed downstream in the printing substrate path, of subsets of a number of removal elements (13), which are arranged offset from one another axially and which can be brought mechanically independently of one another into operative contact with, and/or can be engaged against and disengaged from, the lateral surface (08) of the forme roller (09).

38. The method according to claim 36, characterized in that the printing substrate (02) is printed in a printing press by a non-impact method, in particular by the inkjet method, and is selectively coated, in particular varnished, downstream by means of a coating device (07) according to a method based on a selective removal of previously applied coating medium (06).

39. The method according to claim 36, characterized in that the printing substrate (02) is selectively coated, in particular with primer (06′), in a printing press by means of the coating device (43) according to a method based on a selective removal of previously applied coating medium (06), and downstream is printed by a non-impact method, in particular by the inkjet method.
